(19) United States
(12) Patent Application Publication
(10) Pub. No.: US 2026/0229384 A1
(43) Pub. Date: Aug. 6, 2026

(54) SYSTEM AND METHOD FOR FORMING WIRE AND CABLE

(71) Applicants: DAIKIN AMERICA, INC., Orangeburg, NY (US); DAIKIN INDUSTRIES, LTD., Osaka (JP)

(72) Inventors: Halie Jill MARTIN, Decatur, AL (US); Matthew Philip ORR, Decatur, AL (US); Robert KENNY, Decatur, AL (US)

(73) Assignees: DAIKIN AMERICA, INC., Orangeburg, NY (US); DAIKIN INDUSTRIES, LTD., Osaka (JP)

(21) Appl. No.: 19/576,566

(22) Filed: Mar. 24, 2026

Related U.S. Application Data
(63) Continuation of application No. PCT/IB2024/061070, filed on Nov. 8, 2024.
(60) Provisional application No. 63/547,793, filed on Nov. 8, 2023.

(51) Int. Cl. H01B 3/44; H01B 11/02

(52) U.S. Cl. CPC H01B 3/445; H01B 11/02

(57) ABSTRACT

A system and method for manufacturing wire and cable products with a polymer cable component is provided. The systems and methods include increasing the hardness of a polymer cable component in order to reduce compression and deformation of the cable components during manufacturing. In some instances, the hardness is temporarily increased prior to or during the process of creating twisted pair or during the cabling process.

### CROSS-REFERENCE TO RELATED APPLICATIONS

This application is a Rule 53 (b) Continuation of International Application No. PCT/IB2024/061070 filed Nov. 8, 2024, which claims priority based on U.S. Provisional Patent Application No. 63/547,793, filed Nov. 8, 2023, the respective disclosures of which are incorporated herein by reference in their entirety.

### TECHNICAL FIELD

This disclosure relates to communications cables, and more specifically to high performance communications cables and methods for manufacturing such cables.

### BACKGROUND ART

When transmitting power or signals, various avenues can be utilized. The inventions disclosed herein generally focus on wire and cable products which utilize insulated coated conductors to transmit electrical current.

### SUMMARY OF THE INVENTION

### Technical Problem

In designing wire and cable products, many factors must be considered. Applications such as Ethernet, CATV, and factory-floor based systems can dictate certain design features such as the size, electrical properties, and physical attributes. In the case of size, it can be important the cable fits in standard connectivity, tubing, raceways, and conduit. For electrical properties, capacitance, inductance, DC resistance, current, and voltage carrying capacity can be design considerations. For certain specialized high bandwidth cables, additional electrical parameters such as attenuation, velocity of propagation, delay skew, impedance, insertion loss, and noise mitigation may be important. For physical attributes, resistance to flame and smoke, chemical resistance, ozone resistance, moisture resistance, and/or pull strength are common attributes to consider. Fortunately, there are many tools and equations available to assist the design engineer when considering the best options to construct wire and cable products.

The process for making wire and cable is typically continuous in nature. Continuous manufacturing lines typically include a pay-out where a material is paid-out or dispensed to initiate the line process. There may be an accumulator which helps to reserve a portion of the material being paid out to facilitate consistent line speeds. There is typically a take-up at the end of the line which may also have an accumulator so that the manufactured product can be made at a consistent line speed and the finished product can be taken up onto rolls or other forms of packaging. These types of operations can include insulating, twinning, cabling, braiding, jacketing, and putting up wire and cable products into set lengths, among others. For most wire and cable products, the first step is the insulating process. This is where the conductor is coated or covered with a polymer material to electrically insulate the conductor.

During and after the insulating process, forces will likely be encountered that can impact the ability of the end-product to meet the intended specification. For instance, in the case of coaxial type cables, it is desirable to add a foil and/or metal braid to protect the inner insulation layer and the electrical signal contained within. It is well known that metal braiding equipment can create indentations along the surface of the insulator it is encasing. In other words, the bare strands of braided shielding wire will deform the surface of the insulator below as the insulator surface is often softer than the metal wire being applied onto it. These deformations in the insulation can impact the ability of the final cable to transmit a signal as capacitance and insertion losses increase. To account for these depressions, a design engineer may add extra insulation material to account for the impression depth.

In the case of a multi-conductor cable, various insulated conductors are brought together through a twisting mechanism, often referred to as a twinner, buncher, or cabler. The forces encountered in each of these mechanisms can compress and deform the polymer components of a cable. Again, the cable designer is likely to add insulation to compensate for any compression, thus increasing size, weight, fuel load, and cost of the end-product. Similar compression forces may be experienced during the jacketing and the put-up operations. To compensate for any deformation caused by the compression forces thicker and/or stiffer jacketing and insulation layers may be used, which adds both size and cost to the final product.

Sometimes adverse or compressive forces acting upon a cable component can be cyclical in nature. For instance, if a wheel is not properly aligned, it may wobble back and forth as it transverses in a circular rotation. This can create a sinusoidal deformation of material. If this sinusoidal pattern matches the intended frequency of an application (or any harmonic thereof), signal integrity can be compromised. Existing methods to help reduce the impact of such forces, whether consistent or sinusoidal in nature include reducing manufacturing line speed. Speed can be reduced to alleviate and reduce compression forces caused by manufacturing equipment as the product is made. It is common for equipment to run at a fraction of its potential speed for this reason. This is not desirable however, as the equipment cannot be utilized to its full potential.

Another way in which compressive forces can potentially create problems is with capacitive targets. Capacitance is a function of the distance between metal surfaces, and the characteristics of the materials between those metal surfaces. In the case of wire and cable, a conductive surface can include, among other things, two conductors in close proximity or a shield and a conductor in close proximity. The distance between these conductive surfaces is a key design consideration in making a wire and cable product. So, care is taken to insure the proper conductor to conductor distance is achieved.

In some embodiments, two insulated conductors are formed together to create a twisted pair. Similarly, many insulated conductors may be formed together to create a multi-conductor cabled unit. In the case of two insulated conductors twisted together, a helical pattern is achieved along the length of the twisted pair unit. A twisted pair unit typically consists of metal conductors, insulation material, and air or another gas which is contained in the interstices of the two generally circular insulated conductors or in the cells of foam insulation. It is well known that air is a highly desirable dielectric material. For instance, air has a dielectric of 1.0, where materials such as polyolefin have a typical dielectric range between 2.3 and 2.6. So, the more air preserved within the interstices of the twisted pair unit or the cells of foam insulation, the more desirable the electrical result in the resulting cable. However, as compression forces encountered during the cabling process bring these insulated conductors closer together, the insulation material can be deformed and displaced, thus reducing the total air content. The result can be a higher, generally less desirable, capacitance, and in some cases a reduced signal velocity which can reduce a signal's ability to propagate.

Insulated conductors, such as twisted pair communications cables, are used for high frequency signal transmission, typically in plenum areas of buildings, raised floors, or conduit. In twisted pair data cable embodiments, an individual conductive wire is insulated using a polymer and then two such insulated conductors are twisted around each other to form a single twisted pair. Twisted pair cable is typically composed of multiple twisted pairs contained within a single outer jacket to form a cable. Each twisted pair within a cable may be twisted at a different lay length (conventionally measured in mm/turn) to reduce electrical coupling between adjacent twisted pairs (i.e. crosstalk).

The process of twisting individual insulated conductors together often compresses the polymer insulation layers. The magnitude of the force compressing the insulation layers varies with twisting equipment and the tightness of the twist, (i.e., the number of turns per inch). The compression force caused by twisting the insulated conductors results in a deformation of the insulating layer and a decrease in the thickness of the insulation layers separating the two conductors. In some cases, the compression results in a loss of air content in the cells of foam insulation or from the interstices of the twisted pair.

To compensate for this undesirable loss in insulation thickness and air content, polymer-insulated wire manufacturers typically increase the thickness of the polymer insulation. In general, twisted pairs with a shorter lay length or a tighter twist have greater crush or compression of the polymer insulation (whether foamed or solid). Some twisted pairs are designed to have about 100 ohms impedance. The center to center spacing of the conductors within a twisted pair is a key factor affecting impedance. Therefore, because increased compression brings the conductors closer together, additional insulation thickness is needed to maintain the desired conductor to conductor spacing and impedance as the lay length of twist becomes shorter. Increasing the amount of polymer insulation results in an increase in overall cable weight, fuel load, cable size, and cost.

It also should be mentioned that in the case of torsional forces (a type or force encountered when insulated conductors are twisted together) deformation may not be uniform. This is because insulation may be displaced disproportionally depending on the direction of the torsional force. This is especially undesirable in balanced pair applications. For example, in some applications involving a twisted pair unit with two insulated conductors, it is desirable that the signal in each of the two insulated conductors be a mirror image of the other. In this way, electrical noise which couples with each insulated conductor of the twisted unit couples in the same way, thereby allowing electronic filtering mechanisms to cancel the noise element out. When the shape of one insulated conductor in a pair is disproportional, it becomes challenging to subtract any noise elements from the desired signal. Often specifications for wire and cable products have both near end and far end crosstalk specifications to ensure the amount of noise between transmitting pairs will be low enough not to hinder signal transmission. If insulated conductors are not well balanced, the ability to meet these specifications can become more difficult.

When a cable designer considers how much additional insulation material is needed to offset any insulation displacement or deformation that results from forces encountered during the manufacturing process, the hardness of the insulation material should be understood. Hardness measures a material's resistance to surface deformation. In other words, hardness is resistance to localized surface deformation. Indentation hardness can be measured in various methods including Britnell, Meyer, Vickers, Rockwell, and/or Shore Durometer. For polymer materials such as, for example, Fluorinated Ethylene Propylene (FEP), Polyethylene (PE), Flame Retardant Polyethylene (FRPE), Polypropylene (PP), Polyether ether ketone (PEEK), Polyether ketone ketone (PEKK), polyvinylchloride (PVC), etc., the Shore D hardness scale is commonly used. For other materials such as rubbers, other Shore scales can be used, such as Shore A. In the case of Shore D, the testing protocol is defined in ASTM D2240 and/or ISO 868 and will be used as a baseline hardness reference herein.

It is understood that changes in ambient temperature conditions can impact the hardness of materials. For instance, in warm weather climates, temperature control of a manufacturing floor can be necessary during months in which ambient temperatures are seasonally high, thereby reducing the hardness of any polymer materials on the manufacturing floor. Additionally, when a cable component is subjected to compression, torsion, or other deforming forces, heat is generated within the cable component. In some applications, the forces involved increase the temperature of the component above ambient temperature as it is deformed, thereby reducing the hardness of the component and increasing its susceptibility to deformation at that deformation event as well as any subsequent deformation events.

Conversely, if compounds are cooled below ambient temperature, the hardness of a compound can be increased. This hardening can make the material more resistant to compressive forces which can deform or cause indentations in a material.

It is not always necessary for a hardness adjustment to last beyond a compressive event. For some compressive events, the hardness adjustment may be applied prior to, or during the compressive event. Once the compressive event is over, the material may be allowed to return to its ambient hardness.

It is desirable in the industry to have a method of hardening a compound or reducing the compression forces applied that costs less than adding insulation to counter the effect of deforming a polymer cable component. It is also desirable that any method incorporated to reduce the impact of compression forces upon the insulation can fit within a current machinery footprint with little to no modification in the positioning of the equipment itself. One such method is to control the temperature of a compound to create a shift in the hardness of the compound. It is understood that a harder compound will be less impacted by a given compression force than a softer compound. When using the Shore D scale, higher numbers indicate a harder state of the compound.

By increasing the hardness of a polymer cable components, the deformation of a polymer insulation layer, cross web filler, polymer tube, or other polymer cable component can be reduced. This deformation is typically caused by compression or torsion forces during manufacturing operations such as twisting, braiding, mechanical devices such as sheaves (wheels) and take ups.

What is needed is a new method and apparatus for controlling the deformation of an insulation layer during cable manufacturing to produce a polymer insulated cable that maintains the desired spacing of the conductors by controlling the amount to which insulated conductors compress together during manufacturing. Controlling deformation may help to maintain the desired impedance as well as other electrical and mechanical properties before and after twinning.

### Solution to Problem

This disclosure relates generally to wire and cable products and the creation of wire and cable products with reduced deformation. Some embodiments incorporate a method to alter a material's hardness. Some disclosed embodiments relate to methods for modulating the hardness of a polymer cable component, such as insulation, that may be used in-line as part of a continuous or semi-continuous manufacturing process.

Some disclosed embodiments relate to a communications cable comprising at least one twisted pair of insulated conductors, wherein the insulated conductors comprise a conductor and an insulation layer surrounding a circumference of the conductor and wherein the insulation layer comprises a foamed polymer with foam cells, the foam cells having a major diameter and a minor diameter, and wherein a cross-section of the insulation layer shows at least 50% of the foam cells have a minor diameter that is greater than or equal to 80% of the major diameter.

According to an example embodiment of the present disclosure, a method of controlling the impact of a compressive force on a polymer cable component is provided. A polymer cable component can have a first hardness, which may be the hardness of the polymer cable component under ambient conditions. The method can include temporarily or permanently changing the hardness of the polymer cable component to a second hardness that is different from the first hardness. In some examples, the polymer cable component can be processed by a twinning unit, in which the polymer cable component may be subjected to a compressive force. The method can include allowing the polymer cable component to return to the first hardness.

According to another example embodiment of the present disclosure, a method of manufacturing a communication cable is provided. The method can include providing a polymer cable component. The polymer cable component can have a first cross-section radius and a second cross-section radius. The first cross-section can be a maximum distance from the center of the polymer cable component to the edge of the polymer cable component along a cross-section. The second cross-section can be a minimum distance from the center of the polymer cable component to the edge of the polymer cable component along a cross section. Under ambient conditions, the first cross-section radius can be about equal to the second cross-section radius ±3%. Under ambient conditions, the polymer cable component can have a first hardness. The method can include temporarily changing the hardness of the polymer cable component to a second hardness. The second hardness, in some examples, can be greater than the first hardness. The polymer cable component may be subjected to a process in a twinning unit with a bow. The process may involve subjecting the polymer cable component to a compressive force within the twinning unit. After the compressive force, in some embodiments, the first cross-sectional radius is about equal to the second cross-section radius ±10%.

In another example embodiment of the present disclosure, a method of manufacturing a communication cable is provided. The method can include providing a polymer cable component with a first diameter and a second diameter. The first diameter can be perpendicular to the second diameter ±3%. The polymer cable component can have a first hardness which is the polymer cable component hardness under ambient conditions. The method can include temporarily changing the hardness of the polymer cable component to a second hardness, which can be greater than the first hardness. The method can include processing the polymer cable component in a twinning unit with a bow. The process can include subjecting the polymer cable component to a compressive force. After the compressive force, the first diameter may be within about 10% of the second diameter. The method can include allowing the polymer cable component to return to the first hardness.

In another example embodiment of the present disclosure, a method of manufacturing a communication cable is provided. The method can include providing a first, second, third, and fourth pair of polymer insulated conductors. The pair of polymer insulated conductor can include two polymer insulated conductors. Each polymer insulated conductor can have a first hardness, which can be the hardness of the polymer insulated conductor at ambient conditions. The method can include temporarily changing the hardness of the polymer insulated conductors in the first, second, third, and/or fourth pair of polymer insulated conductors to a second hardness, which can be a different hardness than the first hardness. The method can include twisting the polymer insulated conductors of the first pair together to form a first twisted pair. The first twisted pair can have a first propagation delay over 100 meters. The method can include twisting the polymer insulated conductors of the second pair together to form a second twisted pair. The second twisted pair can have a second propagation delay over 100 meters. The method can include twisting the polymer insulated conductors of the third pair together to form a third twisted pair. The third twisted pair can have a third propagation delay over 100 meters. The method can include twisting the polymer insulated conductors of the fourth pair together to form a fourth twisted pair. The fourth twisted pair can have a fourth propagation delay over 100 meters. The difference in propagation delay over 100 meters for the first, second, third, and fourth propagation delays over 100 meters can be within 50 nanoseconds of each other.

In at least some examples, the change in hardness between the first hardness and the second hardness of a polymer cable component and/or a polymer insulated conductor can be between about 5% and about 95%. In some examples, the change in hardness between the first hardness and the second hardness of a polymer cable component and/or a polymer insulated conductor can preferably be between about 25% and about 75%. In some examples, the change in hardness between the first hardness and the second hardness of the polymer cable component and/or a polymer insulated conductor can be more preferably between about 35% and about 65%.

Some embodiments relate to cables that utilize both foam and solid polymer insulation layers. In such embodiments, the delay skew of the cable may be adjusted by controlling the ratio of foam to solid polymer insulation.

Some embodiments relate to cables that are designed or configured to pass the NFPA 262 Steiner Tunnel Flame Test.

Some disclosed embodiments relate to extended length cables that are greater than 100 meters long.

Some embodiments relate to a cable comprising any of the cables or twisted pairs above.

Some disclosed embodiments relate to methods of manufacturing communications cables to reduce deformation of a polymer cable component and preserver the roundness of the insulated conductors and other cable components.

The disclosed inventions may be applied to any form of polymer cable component or cable construction including, for examples, solid, foam, profile extrusion, insulation layers, hollow tubes, cross-webs, rod fillers, films, tapes, coaxial constructions involving a braiding process, and/or multi-layered insulation.

In addition to reducing the deformation of insulation layers as insulated wires are twisted into twisted pairs, the disclosed invention may be used to reduce the deformation of any polymer material that is exposed to compressive forces such as, for example, braid impressions or mechanical systems such as take ups, sheaves, or wheels.

The above presents a simplified summary in order to provide a basic understanding of some aspects of the claimed subject matter. This summary is not an extensive overview. It is not intended to identify key or critical elements or to delineate the scope of the claimed subject matter. Its sole purpose is to present some concepts in a simplified form as a prelude to the more detailed description that is presented later.

### BRIEF DESCRIPTION OF THE DRAWINGS

The accompanying drawings incorporated in and forming a part of this specification illustrate several aspects of the disclosure, and together with the description serve to explain the principles of the disclosure.

FIG. 1 illustrates a schematic cross section view of an embodiment of an insulated conductor in accordance with this disclosure.

FIGS. 2A and 2B illustrate schematic cross section views of embodiments of a twisted pair.

FIG. 3 illustrates a schematic cross section view of an embodiment of an insulated conductor in accordance with this disclosure.

FIG. 4 illustrates a schematic of an embodiment of an insulated conductor in accordance with this disclosure.

FIG. 5 shows a graph of the OD Collapsing Rate at ambient temperatures for varying lay lengths for Solid, FS, and Foam insulated twisted pairs.

FIG. 6 shows a graph of the OD Collapsing Rate of solid FEP insulated conductor twinned at ambient conditions and Foam and FS insulated conductors that were twinned after being hardened.

FIG. 7 shows a graph comparing the change in impedance (Ohms) between foam FEP insulated conductors and solid FEP insulated conductors twinned at various lay lengths (mm).

FIG. 8 shows a graph comparing the difference in impedance (Ohms) between FS insulated conductors and solid insulated conductors at various lay lengths (mm).

FIG. 9 shows a graph comparing the impedance values (Ohms) of twisted pairs twinned at 2000 TPM or 2500 TPM at various lay lengths (mm).

FIG. 10 shows a graph comparing the delay (ns) of various twisted pairs.

FIGS. 11A-11D show SEM images of a cross section of a foam FEP insulation layer from a twisted pair that was twinned at 2500 TPM with an 8.2 mm lay length under ambient conditions.

FIGS. 12A-12D show SEM images of a cross section of a foam FEP insulation layer from a twisted pair that was twinned at 2500 TPM with an 8.2 mm lay length after being hardened.

FIGS. 13A-13C show schematics of cross sections of foam insulated twisted pairs.

### DESCRIPTION OF EMBODIMENTS

The embodiments set forth below represent the necessary information to enable those skilled in the art to practice the disclosure and illustrate the best mode of practicing the disclosure. Upon reading the following description in light of the accompanying drawings, those skilled in the art will understand the concepts of the disclosure and will recognize applications of these concepts not particularly addressed herein. It should be understood that these concepts and applications fall within the scope of the disclosure and the accompanying claims.

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

The terms “about” and “approximately” shall generally mean an acceptable degree of error or variation for the quantity measured given the nature or precision of the measurements. Typical, exemplary degrees of error or variation are within 20 percent (%), preferably within 10%, and more preferably within 5% of a given value or range of values. Numerical quantities given in this description are approximate unless stated otherwise, meaning that the term “about” or “approximately” can be inferred when not expressly stated. Numerical quantities in the claims are exact unless stated otherwise.

It will be understood that when a feature or element is referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments.

The terminology used herein is for the purpose of describing particular embodiments only and is not intended to be limiting. As used herein, the singular forms “a”, “an” and “the” are intended to include the plural forms as well, unless the context clearly indicates otherwise.

The terms “first”, “second”, and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

In some places reference is made to standard methods, such as but not limited to methods of measurement. It is to be understood that such standards are revised from time to time, and unless explicitly stated otherwise reference to such standard in this disclosure must be interpreted to refer to the most recent published standard as of the time of filing.

This disclosure describes embodiments of wire and cable products as well as methods and systems for creating wire and cable products with improved electrical performance and/or improved manufacturing characteristics. While the disclosed invention is generally discussed in the context of twinning polymer insulated wires to form a twisted pair, it will be appreciated that the disclosed inventions are adaptable to many applications beyond the twinning of insulated conductors including, for example, polymer insulation layers, foamed insulation layers, solid insulation layers, foam skins, cross webs, polymer tape, hollow tubes, rod fillers, jacketing, and other polymer cable components. The disclosure below frequently refers to insulated wires, which comprise a polymer component that serves as an insulator surrounding a conductive component that is generally a conducting metal wire, such as copper or a copper alloy. However, the subject matter described herein may be used for polymer components in other contexts as well.

In some examples, the present disclosure references ambient conditions. Ambient conditions refer to temperature, humidity, and atmospheric pressure conditions typically occurring in indoor spaces.

When polymer insulated conductors are subjected to compression force, such as when twinning wires to form a twisted pair, the polymer insulation component can be compressed or otherwise deformed. For polymer insulation layers, this deformation can disrupt the conductor to conductor spacing of the conductive wires and impact the electrical performance of the wires or resulting cable. For foam insulation, this compression can alter the size, shape, aspect ratio, and/or volume of the cells within the foam insulation material.

In some embodiments, the polymer insulation layer, or a portion of the polymer insulation layer, may be a foamed polymer. In such embodiments, the foamed polymer insulation includes many small pockets of air or other gas. These air pockets are generally known as foam cells. Air is known to be an excellent electrical insulator, therefore incorporating air pockets throughout the polymer insulation layer decreases the dielectric constant of the insulating layer. This is because the dielectric constant of air is 1.0, which is preferable to the dielectric constant of other materials such as FEP (2.0), polyethylene (2.3), and polyvinylchloride (3.5).

While air has excellent dielectric value, it provides no mechanical hardness. Therefore, foam materials or other polymers components that incorporate air will have a lower hardness than a similar component that does not incorporate air. Because air can be incorporated into a polymer cable component in any number of ways (small cells, large cells, cavities, interstices, etc.), ultimately strength will be reduced in accordance with the percentage of air substituted for solid polymer and the size of the air cavities utilized. In some embodiments, the methods for increasing hardness described herein are useful to increase the hardness of the remaining polymer material that is not substituted by air in a polymer foam.

As foamed polymer is more susceptible to deformation than solid polymer, the amount of additional material added to counteract the deformation may be increased. In some embodiments, the Shore D hardness of a foam polymer material is increased by at least about 10% relative to a similar material at 20° C. prior to or during a compressive event.

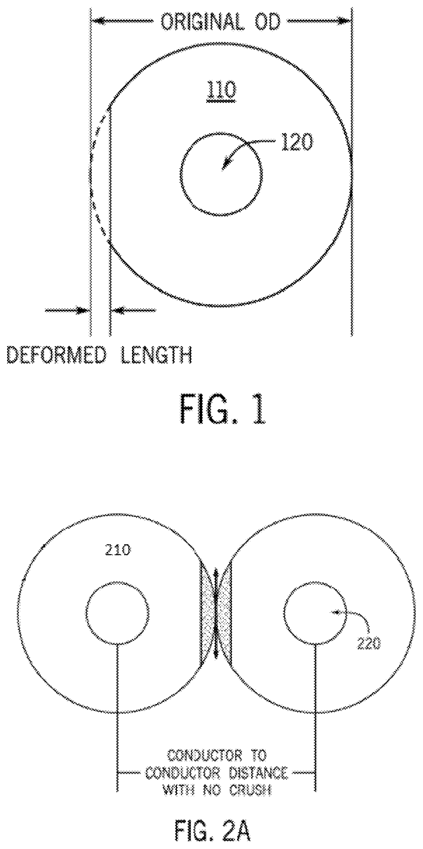

FIG. 1 schematically illustrates a cross section of an insulated wire with a polymer insulation layer 110 around a conductor 120. When an insulated wire is subjected to compression forces, the insulation layer 110 may be deformed. The degree to which the insulation layer 110 is deformed may be described by the crush ratio. The crush ratio is defined as the Deformed Length/Original OD*100 and expressed as a percentage.

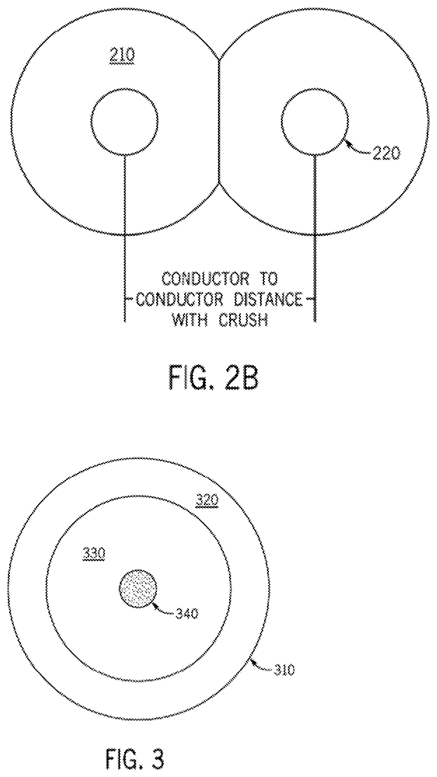

FIG. 2A schematically illustrates a cross section of two insulated wires, each with a polymer insulation layer 210 around a conductor 220. FIG. 2A shows the two insulated wires in contact with each other and with the circular polymer insulation layers not deformed. The shaded area of the polymer insulation layers 210 in FIG. 2A shows the area that is deformed by compression forces when the two wires are twinned together. Insulated wires are frequently referred to as singles, or insulated singles.

FIG. 2B schematically illustrates a cross section of two insulated wires, each with a polymer insulation layer 210 around a conductor 220. FIG. 2B shows the two wires in contact with each other after compression forces have caused a deformation in the polymer insulation layers.

Comparing the conductor-to-conductor distance of the compressed wires in FIG. 2B to the uncompressed wires in FIG. 2A shows that the distance between the two conductors is reduced by the deformation of the two insulation layers. This type of compression can occur when the wires are twinned together or during other compressive events. This decrease in conductor-to-conductor distance has a negative impact on the electrical performance of the twinned wires and any resulting cables.

One of the benefits of the disclosed inventions is the ability to produce twisted pairs and/or other cable designs with improved electrical properties by increasing the hardness and reducing the amount of deformation produced during the twinning, cabling, and/or manufacturing process. One source of deformation of the insulation layers in a twisted pair is the twinning process in which two insulated conductors are twisted around each other. The degree of deformation that occurs during the twinning process is influenced by several factors including, for example, the lay length, wire tension, insulation material, hardness of the insulation, and/or amount of heat generated within the polymer insulation during the twinning process. In order to reduce the deformation as much as possible, it may be desirable to increase the hardness of the insulation material during the twinning process when the insulated conductors are subject to the greatest deformation forces. As discussed, one way to temporarily increase the hardness of the insulation layer is to reduce the temperature. In some embodiments, it is desirable to reduce the temperature of the insulation layer while the wires are being twinned.

The forces applied to a polymer cable component are dependent on the type and manufacturer of equipment utilized by any particular wire and cable company. For instance, there are many different types of cabling machines. Each of those machines will exhibit unique forces against the various elements being cabled. When wire and cable manufacturers determine how much additional insulation to incorporate into a design to offset deformation, it is largely experience, coupled with the knowledge of the hardness of a material, that will ultimately determine how much added insulation will be needed.

Within the industry, the term “wall thickness” is used to capture how much insulation and/or jacketing material is needed to produce the desired product. Most application designs will have an absolute minimum wall thickness, an average minimum wall thickness, a nominal wall thickness, and an absolute maximum wall thickness. When compensating for deformation and depressions in the insulation layers, nominal wall thickness is typically considered.

The softer the insulation material, typically the greater the amount of additional wall thickness necessary to compensate for the wall thickness lost to compression under a given set of conditions. As an example, FEP is a softer insulation than HDPE or PP, and will require a greater amount of additional insulation. Understanding the hardness of an insulation material is useful in determining the amount of compensation needed. If the amount of deformation is controlled, the amount of additional insulation needed can be reduced. This will help with both the size and cost of the final product. In some embodiments, the amount of additional insulation added to produce the desired cable is reduced by at least about 0.0005 inches, or at least about 0.001 inches, at least about 0.003 inches, at least about 0.005 inches, at least about 0.01 inches relative to a cable produced under the same conditions but without using the hardening techniques described herein.

Softer insulation polymers such as fluorinated ethylene propylene (FEP) are more likely to have increased deformation when a force is applied to the insulation layer relative to insulation layers made with harder polymers. Foam insulation layers may also be more susceptible to deformation than solid polymers.

The resistance to deformation of an insulation layer can generally be measured or described in terms of the hardness of the insulation material. As discussed, hardness is a measure of the resistance to localized deformation induced by mechanical indentation or abrasion. In general, different materials differ in their hardness at ambient conditions.

One way to control the hardness and the stress/strain response of a polymer insulation layer is to modulate the temperature of the polymer material. This temperature modulation can be accomplished by any reasonable method such as, for example, exposing the insulation layer directly or indirectly to a chilled, ambient, or warmed fluid such as a liquid or gas. In some embodiments, a polymer cable component can be exposed to chilled water or aqueous solution. In some embodiments, a polymer cable component can be exposed to a cryogenic or chilled fluid, such as liquid nitrogen. In some embodiments, a polymer cable component can be exposed to a chilled gas or vapor. In some embodiments, a polymer cable component can be exposed to one or a plurality of chilled wheels, rollers, tubes, or other solid surfaces. In some embodiments, a polymer cable component may be cooled indirectly. For example, a polymer cable component may pass through the interior of a tube while the exterior of the tube is being cooled. The atmosphere within the tube will be chilled and thereby, cool the polymer cable component. The inventions described herein are generally described in the context of a cryogenic fluid, but any of these methods may also or alternatively be used.

FIG. 3 schematically illustrates a cross section of an insulated wire with a polymer insulation layer around a conductor 340. The insulation layer of the embodiment depicted in FIG. 3 is a single homogeneous polymer layer, however FIG. 3 shows the homogeneous insulation layer as being divided into discrete concentric portions for clarity. The exterior surface 310 of the polymer insulation layer is generally exposed to the outside environment and is subjected to any outside compression forces first. The outer portion 320 of the insulation layer is immediately under the exterior surface. The interior bulk of the insulation layer 330 surrounds the conductor 340 and is the least subject to external compression forces because the exterior surface 310 and outer portion 320 of the insulation layer must both be deformed before impacting the interior bulk 330.

When a polymer insulated wire is exposed to a chilled liquid or a cryogenic fluid, such as, for example, liquid nitrogen, the exterior surface 310 cools rapidly as it is in direct contact with the cryogenic fluid. The outer portion 320 of the insulation layer will be cooled next as heat is pulled out of the insulation layer and into the cryogenic fluid. The speed at which the outer portion of the insulation layer cools will vary based on the thermal conductivity of the polymer material forming the insulation layer. The interior bulk 330 of the insulation layer will cool after the exterior surface and the outer portion. It will be appreciated that a temperature gradient, rather than a sharp line, will be formed separating the outer portion 320 from the interior bulk 330.

As the exterior surface and outer portion of the insulation layer are cooled, the stress/strain response of these portions of the insulation layer may be increased. In some embodiments, this creates a hardened outer portion of the insulation layer which surrounds the relatively less cooled or comparatively higher temperature interior bulk of the insulation layer. If the insulation layer is kept in contact with a cryogenic fluid long enough, eventually, the entire bulk of the insulation layer can be cooled, and the hardness of the entire insulation layer can increase.

It will be appreciated that when a polymer insulated conductor is removed from the cryogenic fluid or other cooling medium and exposed to ambient atmosphere, the polymer insulation will begin returning to ambient temperature. As the temperature increases, the hardness and the stress/strain response of the polymer insulation decreases, and the polymer insulation will become more susceptible to being deformed by a compression force. In some embodiments of the disclosed inventions, a polymer insulation layer or layers are cooled shortly before being subject to a compression event such as, for example, twinning to form a twisted pair. In some applications, the speed at which an insulated conductor is moving and the distance between a cooling vessel and twinner take-up will determine the time that a polymer insulated conductor is exposed to ambient atmosphere after being cooled, but before being subjected to a compression force. In some embodiments, the end of the cooling vessel is less than 10 feet from the point at which the polymer insulated conductor is subjected to a subsequent compressive force. In some embodiments, the end of the cooling vessel is less than 8 feet, 6 feet, 4 feet, or 2 feet away from the point at which the polymer insulated conductor is subjected to a subsequent compressive force.

It will be appreciated that the disclosed inventions do not require a permanent change to the composition of the polymer insulation material. The composition of the polymer insulation layer remains unchanged while the polymer insulation is cooled, thereby modifying the stress/strain response. The composition of the polymer insulation layer remains unchanged as the insulation is subjected to any compression or deformation forces and as the polymer insulation is allowed to return to ambient temperature, thereby reducing its hardness.

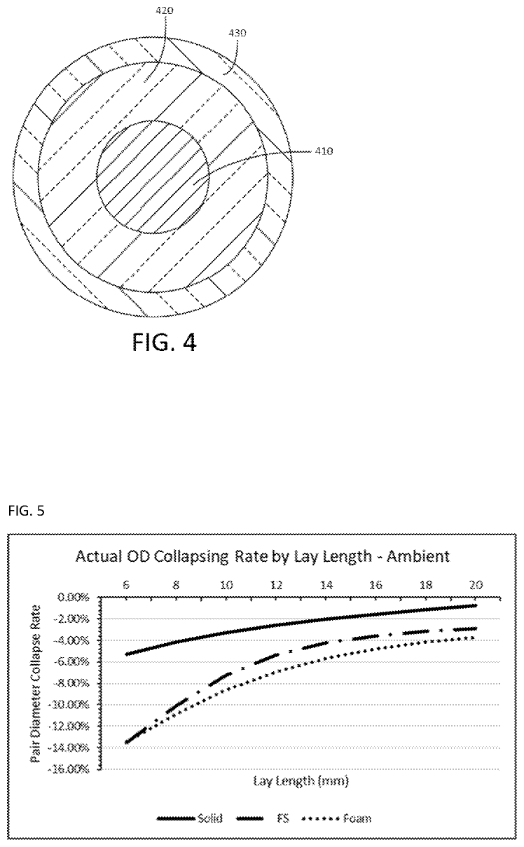

FIG. 4 schematically illustrates a cross section of an embodiment in which a conductor is insulated by multiple insulating layers. In some embodiments, multiple layers of different insulation materials may be used to surround a conductor. In some embodiments, a layer of an outer material with a higher intrinsic hardness may be used to help reduce the compression of a layer of a softer inner material. In some embodiments, a layer of foam insulation 420 may be used to insulate the conductor 410. The hardness of a foamed insulation layer can be significantly lower than the hardness of a solid insulation layer of the same polymer material because the foam insulation contains many discrete air pockets. The foam insulation layer may therefore be more susceptible to compression during manufacturing. A skin layer 430 of a harder material than the underlying foam insulation 420 may be used to reduce compression of the foam insulation. The hardness of the outer portions of the insulation material can be temporarily increased in order to reduce compression or deformation of the insulation layers during the manufacturing or cabling process. It will be appreciated that the entire thickness of the inner foam insulation layer may not need to be hardened in order for the outer portions of the foam insulation layer to have a temporarily increased hardness and resist compression during the cabling process. It will also be appreciated that the skin 430 may or may not be a foam itself. In some embodiments, the skin will be a solid polymer designed to protect an underlying foam insulation layer. In some embodiments, the skin layer will include a different polymer than the underlying insulation layer.

In one illustrative example, three different twisted pairs of fluorinated ethylene propylene (FEP) insulated conductors were created using a twinner set to 2500 twists-per-minute. The lay lengths of the different samples were varied from about 6 mm to about 20 mm. The different twisted pairs included conductors insulated entirely with solid FEP (“Solid”); conductors insulated with an interior layer of foam FEP and an outer layer of solid FEP (“Foam Skin” or “FS”); and conductors insulated with only foamed FEP (“Foam”). The outer diameters of the insulated singles discussed in FIGS. 4-7 were the same before twinning.

The OD Collapsing Rate compares the outer diameter (“OD”) of a twisted pair to a hypothetical twisted pair which experiences zero crush or deformation. This can be used to quantify the amount of deformation that occurs during the twinning process. The OD of the hypothetical twisted pair is calculated as twice the OD of an original insulated single before twinning. The OD Collapsing Rate is calculated by:

$$O D Collapsing Rate = \frac{Measured Pair Diameter - ( 2 * O D )}{2 * O D}$$

FIG. 5 shows a graph of the OD Collapsing Rate at ambient temperatures for varying lay lengths for Solid, FS, and Foam insulated twisted pairs. As can be seen from FIG. 5, the OD Collapsing Rate is generally expressed as a negative number. The OD Collapsing Rate generally has a greater absolute value when the lay length is shorter. This is reasonable as the compressive forces are generally greater when the lay length is shorter. At ambient conditions, the solid FEP insulation collapses significantly less at all lay lengths relative to either the Foam or FS insulated twisted pairs.

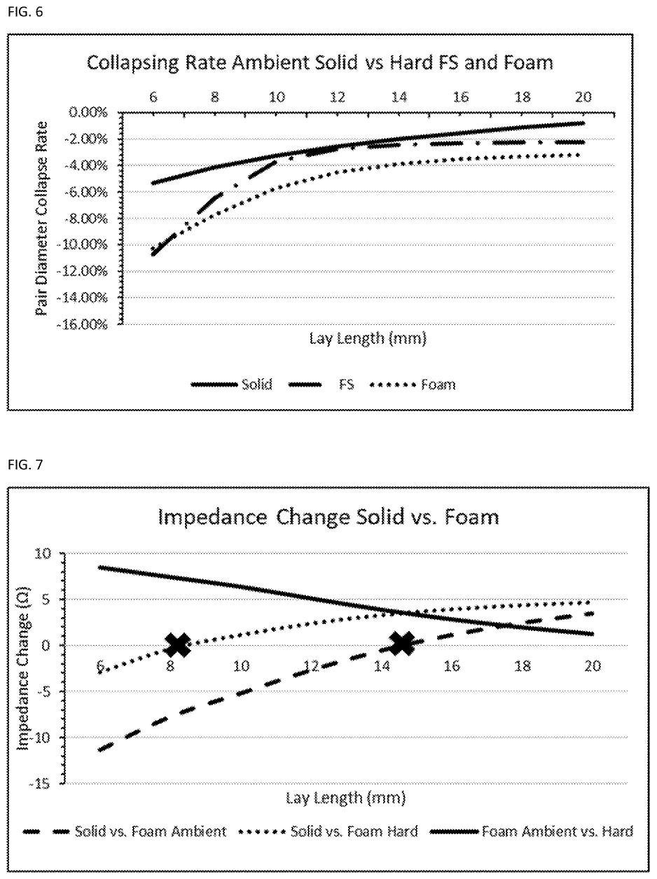

FIG. 6 shows a graph of the OD Collapsing Rate of the solid FEP insulated conductors twinned at ambient conditions and Foam and FS insulated conductors that were twinned after being hardened. In this example, the Foam and FS insulated conductors were exposed to liquid nitrogen for between about 1 and 15 seconds before being twinned.

As can be seen in FIG. 6, the hardened Foam insulated conductors experienced significantly more deformation than the solid insulated conductors that were twinned without hardening. Conversely, the hardened FS insulated conductors had an OD Collapsing Rate similar to the solid insulated conductors when the lay lengths were between about 10 mm and about 14 mm. This shows that FS insulated conductors can be utilized with a significantly decreased collapsing rate if the FS insulation is hardened prior to a compressive event such as twinning.

FIG. 7 shows a graph comparing the change in impedance (Ohms) between foam FEP insulated conductors and solid FEP insulated conductors twinned at various lay lengths (mm). All of the twisted pairs in this example were twinned at 2500 TPM. All of the solid FEP insulated samples were twinned at ambient conditions. The two Xs on the graph indicate unity in the impedance of the sample and the solid FEP insulated conductors twinned at ambient conditions.

In FIG. 7, the dashed line shows that foam insulated conductors that were twinned at ambient conditions had a lower impedance than solid insulated conductors that were twinned at ambient conditions at lay lengths of less than about 15 mm. At lay lengths greater than 15 mm, it is believed the compression forces are low enough that the enhanced electrical properties of the foam insulation more than compensate for the increase deformation experienced by the foam insulation.

In FIG. 7, the dotted line shows that foam insulated conductors that are hardened prior to twinning have a greater impedance than solid insulated conductors that are twinned at ambient conditions at lay lengths of more than about 8 mm. Without being bound by theory, it is believed that the increased hardness of the hardened foam insulation reduced the amount of deformation of the foam insulation layer, thereby allowing the hardened foam insulated twisted pair to have a higher impedance value than the solid insulated pair at a broader range of lay lengths.

In FIG. 7, the solid line shows that foam insulated conductors that are hardened prior to twinning have a greater impedance value than the foam insulated conductors that are twinned at ambient conditions. The difference in impedance values between the hardened foam insulated conductors and the ambient foam insulated conductors decreases as the lay length increases.

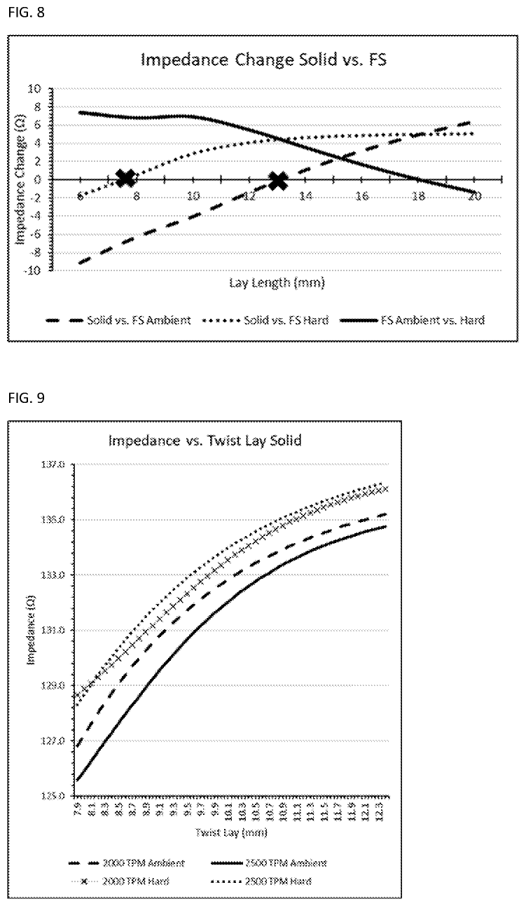

FIG. 8 shows a graph comparing the difference in impedance (Ohms) between FS insulated conductors and solid insulated conductors at various lay lengths (mm). All of the twisted pairs in this example were twinned at 2500 TPM.

In FIG. 8, the dashed line shows that the FS insulated conductors that were twinned at ambient conditions had a lower impedance value than solid insulated conductors that were twinned at ambient conditions at lay lengths of less than about 13 mm. The dotted line in FIG. 8 shows that FS insulated conductors that were hardened prior to twinning had a greater impedance value than solid insulated conductors that were twinned at ambient conditions at lay lengths greater than about 7.5 mm.

In FIG. 8, the solid line shows that FS insulated conductors that were hardened prior to twinning generally had a greater impedance than FS insulated conductors that were twinned at ambient conditions at lay lengths less than about 18 mm. The difference in impedance between the hardened FS insulated conductors and the ambient FS insulated conductors generally decreases as the lay length increases.

FIG. 8. shows that twisted pairs may be made with hardened FS insulated conductors or hardened foam insulated conductors rather than ambient solid insulated conductors to create twisted pairs with greater impedance values at lay lengths greater than about 7.5 mm. In some embodiments, a twisted pair with similar electrical properties to a solid insulated twisted pair may be created using less foam or FS insulation if the insulation is hardened prior to twinning.

FIG. 9 shows a graph comparing the impedance values (Ohms) of twisted pairs twinned at 2000 TPM or 2500 TPM at various lay lengths (mm). At each twinning speed there are also twisted pairs made with or without the disclosed hardening technology.

As can be seen from FIG. 9, the twisted pairs made using the hardening technology had a higher impedance value than the twisted pairs made without using the hardening technology at both 2000 and 2500 TPM. The highest impedance value twisted pair was made at 2500 TPM. This is counterintuitive because twinning at a higher TPM results in larger compressive forces which typically cause lower impedance values. When comparing the twisted pairs made at ambient conditions, they follow the standard trend. When comparing the twisted pairs made using the hardening technology, the twisted pair made at 2500 TPM have a higher impedance value than the twisted pair made at 2000 TPM. This improved electrical performance at higher a TPM allows for the development of cables made at higher TPMs, faster line speeds, and/or with less total insulation.

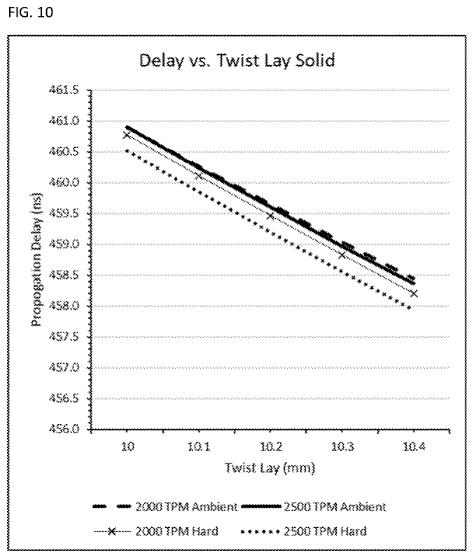

FIG. 10 shows a graph comparing the delay (ns) of various twisted pairs twinned at either 2000 TPM or 2500 TPM at lay lengths between 10.0 and 10.5 mm. These samples were made either with or without the disclosed hardening technology.

As can be seen from FIG. 10, the twisted pairs made using the hardening technology had reduced delay at all lay lengths for the samples made at both 2000 TPM and 2500 TPM. The largest improvement was again seen in the sample twinned at 2500 TPM.

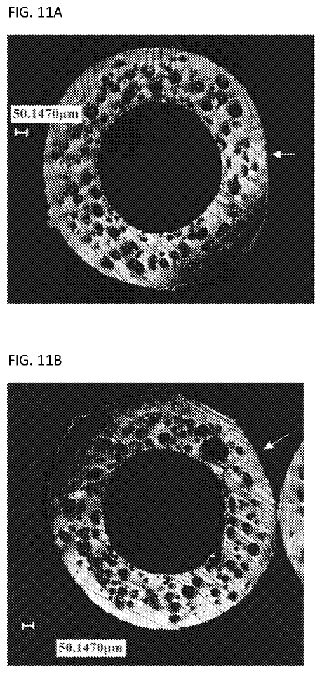

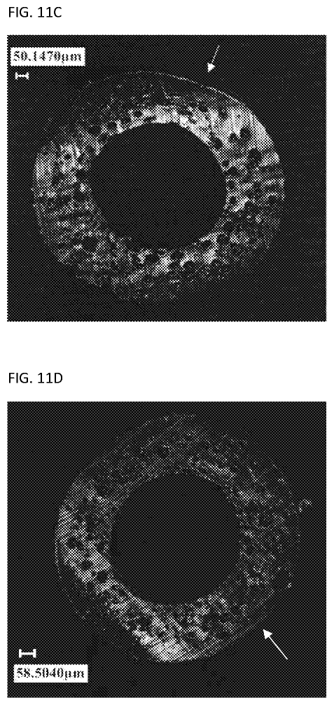

FIGS. 11A-11D show SEM images of a cross section of a foam FEP insulation layer from a twisted pair that was twinned at 2500 TPM with an 8.2 mm lay length under ambient conditions. These figures show cross sectional images of foam insulated conductors with several air pockets or foam cells distributed throughout the insulation layers. It will be appreciated that these air pockets are closed and do not allow air, or any other fluids, to travel through the insulation layer. As indicated by the arrows, the originally circular shapes of the cross sections show a distinct area where the insulation layer has been deformed by the compressive forces of twinning.

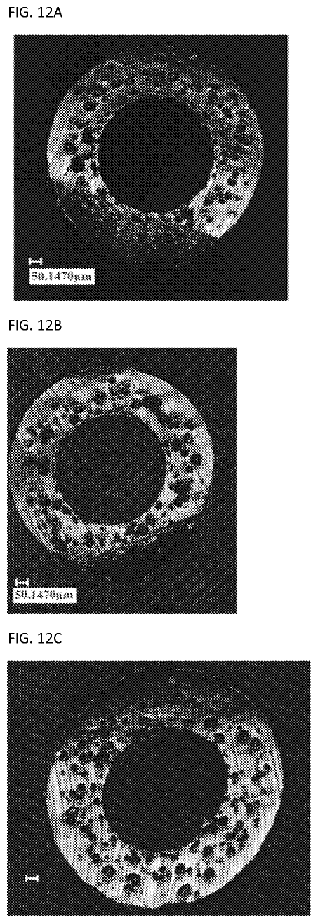

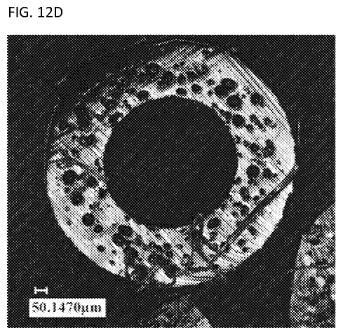

In contrast, FIGS. 12A-12D show SEM images of a cross section of a foam FEP insulation layer from a twisted pair that was twinned at 2500 TPM with an 8.2 mm lay length after being hardened. As indicated by the arrows, the originally circular shapes show a significant reduction in the degree of deformation of the insulation layer where it has been compressed during twinning.

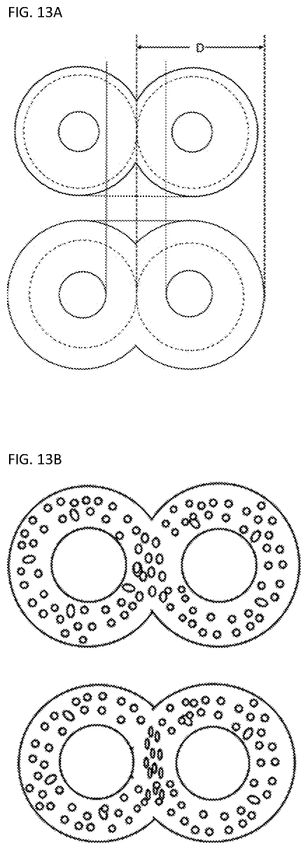

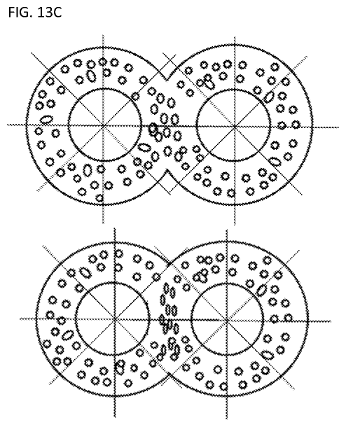

FIGS. 13A-13C show schematics of cross sections of foam insulated twisted pairs. FIG. 13A shows two twisted pairs made under different conditions. The upper twisted pair shows smaller diameter insulated singles that were twinned after being hardened. The lower twisted pair shows larger diameter insulated singles that were twinned at ambient conditions. After being twisted together, the conductor-to-conductor spacing in the upper twisted pair is larger despite the lower twisted pair utilizing larger diameter insulated singles. FIG. 13A also shows that more air is contained in the interstices of the upper twisted pair relative to the lower twisted pair.

FIG. 13B shows the foam cells of two twisted pairs made under different conditions. Both twisted pair schematics show the foam cells in between the conductors have been compressed during the twinning process. This region is referred to as the compressed region. Conversely, in this example, the foam cells in the twisted pair that are not in the compressed region remain generally uncompressed, even after twinning. This region is referred to as the non-compressed region. In general, the compressed region of a twisted pair includes the portion of the insulation layers that are between the two conductors. A key feature of the compressed region is that the insulation layer has been compressed more in that region than in the other non-compressed regions. In some embodiments, the compressed region includes about ¼th of the cross section of the insulation layer.

FIG. 13B shows an upper twisted pair that was twinned after being hardened and a lower twisted pair that was twinned at ambient conditions. The foam cells in the compressed region of the upper twisted pair are less compressed than the foam cells in the compressed region of the lower twisted pair. As air has a lower dielectric constant than the polymer insulation, the more air that remains in the foam cells and interstices, the better the performance of the resulting twisted pair. Similarly, the less compressed the foam cells of a twisted pair, the better the performance of the resulting twisted pair. A twisted pair that is less compressed will also retain a larger conductor-to-conductor spacing, which is also beneficial for the electrical performance of the twisted pair and any resulting cable.

FIG. 13C shows the same twisted pairs as FIG. 13B, with overlaid radial lines showing that the compressed region can include approximately ¼th of the insulation layer. In some embodiments, the compressed region is the region between the two conductors. In some embodiments, the compressed region is the region within about 45 degrees of a line drawn between the two conductors.

While FIGS. 13A-C show a schematic of twisted pair, it will be appreciated that the same concept applies to other foam polymer cable components such as fillers, cross-webs, tapes, straws, etc.

In some embodiments, reducing the crush or deformation of polymer insulated conductors, cables, cable jackets, and other cable components allows those components to be made using less polymer material while maintaining or improving electrical performance. By using less polymer material, the resulting twisted pairs and cables contain less flammable material and have a lower fuel load. Cables with a lower fuel load are more likely to pass the NFPA 262 Steiner Tunnel Flame Test.

In some embodiments, the step of adding additional insulation and/or jacketing materials to compensate for the expected deformation creates a new set of problems. For example, many cables must pass certain flame and smoke standards, which ensure the cables are safe for use within a building or residence. One element of a cable's propensity to propagate a flame and generate smoke is the amount of flammable material contained within it, commonly referred to as “fuel load.” Generally, when the amount of fuel (in this case polymer insulation, jacketing, or other polymer material) is increased, the result is more smoke generation and/or flame propagation from the cable being tested.

An example of fuel load testing is the NFPA 262 Steiner Tunnel Flame Test, which is related to ASTM E84, NFPA 255, UL 723 and ULC S102. In the NFPA 262 Steiner Tunnel Flame Test, a bundle of cable is placed in a noncombustible horizontal box or tunnel is subjected to a flame. A standardized flame intensity is used, and air is moved through the tunnel to simulate a plenum ceiling situation. Materials tested to these standards are required to exhibit a maximum flame spread distance of 5 feet, a maximum peak optical density of 0.5, and a maximum average optical density of 0.15.

Design engineers generally choose materials that are optimized for cost and for meeting the required fuel load standards. A potential problem occurs when extra materials are added to compensate for cable deformation due to forces incurred during the making of cables. This extra material increases fuel load, drives up cost, and limits the type of materials that may be employed. As an example, some Cat 6A cables use shorter lay lengths to enable higher data speeds. These shorter lay lengths typically create higher compressive forces during manufacturing. These cables typically use FEP resins for insulation, due to the higher than normal deformations encountered during the making of these products. Some other Cat 6 cables utilize longer lay lengths and experience comparatively reduced compression forces during manufacturing. These cables therefore need less additional insulation to compensate for deformation. This lower fuel load allows other less costly materials to be utilized.

In some embodiments, a cable is manufactured by temporarily increasing the hardness of a polymer cable component prior to or during a compressive event. The increased hardness reduces the degree of deformation experienced during the compressive event and therefore, less additional insulation material is required to achieve the desired electrical performance. In some embodiments, increasing the hardness of a polymer cable component allows for a reduced total fuel load in the resulting cable, thereby allowing the cable to pass the NFPA 262 Steiner Tunnel Flame Test, whereas a similar cable that did not experience an increase in hardness and included additional polymer material to offset the increased deformation would not pass the NFPA 262 Steiner Tunnel Flame Test.

In some embodiments, cables with a lower fuel load may be developed that would not have passed the NFPA 262 Steiner Tunnel Flame Test without the reduced fuel load. In some embodiments, cables made using the disclosed technology contain a reduced fuel load and propagate less flame or smoke.

In some embodiments, cables created using the disclosed technology may have a smaller outer diameter. This may allow existing buildings to be retrofitted with modern high-performance cables that have an equal or smaller diameter as the lower performance cables that were used previously.

In some embodiments, a wire and cable product has a certain amount of polymer insulation and/or other polymer component that contributes to its fuel load. In some embodiments, the fuel load is designed to produce a flame travel distance of equal to or less than about five feet, a peak optical density of smoke equal to or less than about 0.5 and/or an average optical density equal to or less than about 0.15 when measured according to the NFPA 262 Steiner Tunnel Flame Test.

In some embodiments, a polymer cable component is cooled and/or hardened before going through a compressive event. Due to the hardening, the polymer cable component is able to provide the desired electrical properties as it is not deformed as much as it would have been if the polymer cable component had not been cooled and/or hardened before being compressed. In some embodiments, reduced fuel load wire and cable products have a capacitance value of less than about 20 pF/ft. In some embodiments, reduced fuel load wire and cable products have an impedance value of between about 50 ohms and 150 ohms, or between about 75 ohms and 125 ohms, or between about 85 and 115 ohms, or equal to about 100 ohms. In some embodiments, reduced fuel load wire and cable products have a velocity of propagation of between about 62% of the speed of light and 80% of the speed of light, or between about 66% of the speed of light and 70% of the speed of light.

The limiting oxygen index (“LOI”) is the minimum concentration of oxygen, expressed as a percentage, that will support combustion of a polymer. Different polymers have different LOI values. The higher the LOI, the less flammable the polymer generally. For example, polyethylene has an LOI of about 18%, flame retardant polyethylene (FRPE) has an LOI of about 33%, and FEP has an LOI of about 90%. Accordingly, cables made with FEP generally perform better on the NFPA 262 Steiner Tunnel Flame Test compared to cables made with PE or FRPE.

Foam insulated cables use less total polymer insulation for a given insulation wall thickness as the foam contains a significant amount of air as well as polymer. Because foam insulation contains less total polymer, foam insulated conductors have less total fuel load. It should be noted that the total fuel load of a cable includes all of the other cable components such as, for example, tape wrap, cross web, fillers, inner jackets and/or outer jackets.

Many cables contain four twisted pairs of insulated conductors. In some embodiments, a cable contains one, two, or three twisted pairs that are insulated with FEP and the remaining twisted pairs are insulated with FRPE or another non-fluoropolymer. In some embodiments, such a cable is a Cat 6A cable that passes the NFPA 262 Steiner Tunnel Flame Test. Such a cable may be manufactured using the disclosed hardening techniques which can result in a lower fuel-load cable while maintaining or improving the electrical properties of the cable.

In certain embodiments a cable containing four FRPE foam insulated twisted pairs is a Category 6A cable and passes the NFPA 262 Steiner Tunnel Flame Test. In some embodiments, a cable may be manufactured with one, two, three, or four foam FRPE insulated twisted pair by temporarily hardening the foam FRPE insulated singles prior to twinning them to form twisted pairs. By hardening the foam polymer insulation, the electrical performance of a cable containing foam FRPE insulation may be increased to meet or exceed the Category 6A performance standards in plenum rated cables. In some embodiments, the use of polymer foam insulation reduces the total fuel load of the cable, allowing the cable to meet or exceed the standards of the NFPA 262 Steiner Tunnel Flame Test.

Communications cables are typically 100 m long or less. This distance is limited by the velocity of propagation and the attenuation loss of the cable. Utilizing the disclosed hardening techniques, the velocity of propagation and the attenuation loss of a cable can be improved, thereby allowing for a longer length of cable.

Communication cables typically have four twisted pairs, each with a different lay length. The electrical performance of the twisted pair with the shortest lay length, or tightest twist, typically limits the total length of the overall cable. In some disclosed embodiments, the twisted pair with the shortest lay length is insulated with a foam polymer and the twisted pair with the longest lay length is insulated with a solid polymer. By hardening the foam polymer insulation prior to twinning the insulated conductors to form a twisted pair, the electrical performance of the resulting twisted pair can be improved and the total length of the resulting cable can be extended. In some embodiments, the insulated conductors of one or more twisted pairs are insulated with foam polymer that is hardened prior to twinning. Using the methods and techniques disclosed herein, a cable can be constructed with a data transfer rate of at least 10 gigabits per second at a frequency of at least 500 MHz. In some embodiments, such a cable can be at least 120 meters long, or at least 130 meters long, or at least 150 meters long. In some embodiments, the cable is a category 6A cable, meaning the cable passes the relevant Category 6A standard. In some embodiments, at least one twisted pair within the cable has a lay length of about 8.2 mm or less.

In some embodiments, by increasing the hardness of a polymer insulated conductor, the conductor will retain a more circular cross-section rather than being deformed by a compressive force. This can reduce the amount of surface-to-surface contact between two polymer insulated conductors and reduce friction or torsion forces between the insulated conductors.

In some embodiments, a cable is made without significantly or only somewhat deforming the polymer cable components incorporated in the cable. Many polymer cable components have a generally circular cross section with about equal major and minor diameters. Similarly, generally circular cross section of many polymer cable components will have many radii that are about equal to each other before the cable is compressed or deformed. To be clear, before the polymer cable component is compressed or deformed, the radii with the maximum length is about equal to the radius with the minimum length. While there is some natural deviation in the wall thickness of a polymer cable component, the maximum and minimum radii are generally within 3% of each other. In some polymer cable components, the initial maximum and minimum radii may be within 5% of each other prior to being compressed or deformed.

In some embodiments, the generally circular cross section of a polymer cable component is preserved after the polymer cable component is subjected to a compression or deformation force. By increasing the hardness of the polymer cable component as described herein, the polymer component may be less deformed, thereby maintaining its generally circular cross section. In some embodiments, after the polymer cable component is subjected to a compressive force, the maximum and minimum length radii of the cable component are within about 10% of each other. In some embodiments, the maximum and minimum length radii are within about 8% or about 5% of each other. In some embodiments, the maximum and minimum length radii are within about 20%, about 15% or about 12% of each other. It will be appreciated that the closer to equal the maximum and minimum length radii are to each other, the closer to circular the cross section is and the less deformed the polymer cable component.

In some embodiments, a polymer insulated conductor or other polymer cable component is cooled to increase the hardness prior to being subject to a compressive force. In some embodiments, the reduced temperature of the polymer cable component offsets any heat generated within the polymer cable component by the compressive force. In some embodiments, the temperature of the polymer cable component during or immediately following a compressive event is equal to or less than the ambient temperature.

In some embodiments, a twisted pair is disclosed. The twisted pair comprising a pair of insulated conductors. The insulated conductors comprising a conductor and an insulation layer surrounding a circumference of the conductor. In some embodiments, the insulation layer comprises a layer of solid polymer. In some embodiments, the insulation layer comprises a layer of foamed polymer. In some embodiments, the insulation layer comprises multiple layers of foam and/or solid polymer. In some embodiments, the insulation layer comprises a foamed polymer with foam cells. A cross section of the foam polymer shows that the foam cells have a major diameter and a minor diameter for that cross section. The major diameter being the largest length diameter of the foam cell cross section and the minor diameter being the smallest length diameter of the foam cell cross section. Prior to experiencing a compressive event, the major and minor diameters of the foam cells are generally within 10% of each other. After being exposed to a compressive force, foam insulation and the foam cells are typically deformed, thereby creating a larger difference between the major and minor diameters. In some disclosed embodiments, a twisted pair has a foam insulation layer, wherein a cross section of the twisted pair shows that at least about 50%, about 70%, about 80%, or about 90% of the foam cells have a minor diameter length within 10% of the major diameter length, or within 15% of the major diameter length, or within 20% of the major diameter length.

In some disclosed embodiments, a cross section of the twisted pair shows that at least about 50%, about 75%, about 85%, or about 95% of the foam cells have a minor diameter that is greater than or equal to about 70% about 80%, about 90%, or about 95% of the major diameter.

In some embodiments, a cross section of a twisted pair will show a compressed region and a non-compressed region of a foam insulation layer around a conductor. The compressed region is understood to be the portion of the cross section of a foam insulation layer that was deformed during the twinning process. In some embodiments, the foam cells within the compressed region of a foam insulation layer have a minor diameter within about 5%, about 10%, about 15% or about 20% of the major diameter. In some embodiments, the foam cells within the compressed region have an average minor diameter that is greater than or equal to 70%, or 80%, or 90%, or 95% of the average major diameter.

A cross section of a foam insulation layer will show a plurality of foam cells or voids that make up a certain area of the cross section. Similarly, there will be a plurality of polymer areas with a calculable combined area within the cross section. The ratio of total foam cell area to total polymer area may be used to show the degree of deformation in a certain region of a foam polymer cable component. In some embodiments, the ratio of foam cell area to polymer area in the compressed region of a foam insulation layer will be within about 5%, about 10%, about 15%, or about 20% of the ratio of the foam cell area to polymer area in the non-compressed region of the foam insulation layer. In some embodiments, the foam cell to polymer ratio within the compressed region is greater than or equal to 70%, or 80%, or 90%, or 95% of the foam cell to polymer ratio in the non-compressed region.

In a foam insulation layer, the weight of a cross sectional slice or a portion of a cross sectional slice of a foam insulation layer may be used to determine or approximate the total air content, as opposed to polymer content, of that portion of the foam insulation layer. In some embodiments, the weight per volume of the foam insulation within the compressed region of a foam insulation layer is less than about 20% greater, less than 10% greater, or less than 5% greater than the weight per volume of the foam insulation in the non-compressed region of the foam insulation layer. In some embodiments, the weight per volume of the foam insulation within the compressed region is less than or equal to 110%, or 115% or 120%, or 125%, or 130% of the weight per volume of the foam insulation in the non-compressed region.

In some embodiments, a cross section of the foam insulation layer contains at least 15% air by volume, at least 20% air by volume, at least 25% air by volume, or at least 30% air by volume.

In some embodiments, the insulation layer comprises a fluoropolymer. In some embodiments, the insulation layer comprises FEP, PFA, PTFE, PVDF, or ETFE. In some embodiments, the insulation layer comprises a fluorinated fluoropolymer with less than about 50 unstable end groups per million carbon atoms. In some embodiments, the insulation layer comprises an un-fluorinated fluoropolymer with more than about 50, or more than about 100, or more than about 150, or more than about 200, or more than about 300, or more than about 500 unstable end groups per million carbon atoms. It will be appreciated that unstable end groups include at least COOH, CF₂H, COF, CH₂OH, CONH₂, CH₂OH.

In some embodiments, a method for manufacturing a twisted pair is disclosed. In some embodiments, a method comprises providing a first foam insulated conductor comprising a first conductor electrically insulated by a first foam insulation layer and a second foam insulated conductor comprising second conductor electrically insulated by a second foam insulation layer. A first foam insulation layer has a first hardness at ambient conditions. In some embodiments, a method comprises hardening the first foam insulation layer to a second hardness, which is greater than the first hardness and then twisting the first and second foam insulated conductors around each other to form a twisted pair while the first foam insulation layer is at the second hardness. In some embodiments, the method comprises compressing the first insulation layer or exposing the first insulation layer to a compressive event while the first foam insulation layer is at the second hardness.

In some embodiments, the method further comprises hardening the second foam insulation layer from a third ambient hardness to a fourth hardness, the fourth hardness being greater than the third hardness.

In some embodiments, the step of twisting the first and second foam insulated conductors around each other occurs within 30 seconds after hardening the first foam insulation layer to a second hardness, or within 20 seconds, or within 10 seconds or within 5 seconds after hardening the first foam insulation layer to a second hardness.

In some embodiments, the first and second foam insulated conductors are twisted around each other at greater than 1400 twists per minute (TPM), or greater than 1600 TPM, or greater than 1800 TPM, or greater than 2000 TPM.

In some embodiments, the step of hardening the first foam insulation layer comprises cooling the first foam insulation layer. In some embodiments, an insulation layer or other polymer cable component may be hardened by cooling, cross-linking, irradiation, or using chemical agents. It will be appreciated that some of the hardening techniques listed herein permanently harden the polymer cable component, while others harden the polymer cable component only temporarily.

In some embodiments, the hardening of the first insulation layer is temporary and the hardness of the first insulation layer returns to the first hardness at ambient conditions. In some embodiments, the first insulation layer returns to the first hardness within 100 seconds of the forming a twisted pair, or within 80 seconds, or within 60 seconds, or within 40 seconds, or within 30 seconds or within 15 seconds of forming a twisted pair or otherwise exposing the first insulation layer to a compressive event.

In some embodiments, a method of manufacturing a communications cable comprises providing a first polymer foam cable component, the polymer foam cable component comprising a polymer foam with foam cells, the first polymer foam cable component having a first hardness under ambient conditions and hardening the first polymer foam cable component to a second hardness, the second hardness being greater than the first hardness.

In some embodiments, the method comprises compressing at least a portion of the first polymer foam cable component to form a communications cable while the first polymer foam cable component is at the second hardness. In some embodiments, the compression is caused by a metal braid, foil wrap, tape wrap, roller, capstan, sheeve, or other cable component. In some embodiments, the polymer foam cable component comprises a fluoropolymer. In some embodiments, the polymer foam cable component comprises FEP. In some components, the FEP contains greater than 50 unstable end groups per million carbon atoms. In some components, the FEP contains greater than 80, or greater than 100, or greater than 150, or greater than 200 unstable end groups per million carbon atoms.

It will be appreciated that the act of installing communications cable in a building often involves dragging, scraping, or otherwise applying compressive force to a polymer cable component. In some embodiments, a method of installing communications cables in a building comprises providing a first polymer foam cable component, the polymer foam cable component comprising a polymer foam with foam cells, the first polymer foam cable component having a first hardness under ambient conditions and hardening the first polymer foam cable component to a second hardness, the second hardness being greater than the first hardness. In some embodiments, the method further comprises positioning at least a portion of the first polymer foam cable component into a desired location of a building while the first polymer foam cable component is at the second hardness. In some embodiments, the method comprises allowing the first polymer foam cable component to return to the first hardness.

In some embodiments, a method of manufacturing a communications cable comprises providing a plurality of polymer insulated conductors that are insulated by a polymer foam having a first hardness under ambient conditions and dividing the plurality of polymer insulated conductors into pairs. The method further comprises hardening the polymer foam of a first pair of polymer insulated conductors to a second hardness, the second hardness being greater than the first hardness and twisting the first pair of polymer insulated conductors to form a first twisted pair. In some embodiments, the method comprises hardening the polymer foam of a second pair of polymer insulated conductors to a third hardness, the third hardness being greater than the second hardness; and twisting the second pair of polymer insulated conductors to form a second twisted pair.

In some embodiments, the method further comprises hardening the polymer foam of a third pair of polymer insulated conductors to a fourth hardness, the fourth hardness being greater than the third hardness; and twisting the third pair of polymer insulated conductors to form a third twisted pair.

In some embodiments, the step of twisting the first pair of polymer insulated conductors occurs within 30 seconds after hardening the polymer foam of a first pair of polymer insulated conductors to a second hardness or within 20 seconds, or within 10 seconds, or within 5 seconds of hardening the polymer foam of the first pair of polymer insulated conductors to the second hardness.

In some embodiments, a cross section of the polymer foam of the first twisted pair contains at least 15% air by volume. In some embodiments, a cross section of the polymer foam of the first twisted pair contains at least 10% air by volume, or at least 20% air by volume, or at least 25% air by volume.

In some embodiments, a lay length of the first twisted pair is longer than a lay length of the second twisted pair. In some embodiments, the lay length of the second twisted pair is longer than the lay length of the third twisted pair. In some embodiments, the lay length of the third twisted pair is longer than the lay length of the fourth twisted pair.

In some embodiments, the electrical impedance value of the first twisted pair is within about 10 Ohms of the electrical impedance value of the second twisted pair. In some embodiments, the electrical impedance value of the first twisted pair is within about 5 Ohms of the electrical impedance value of the second twisted pair. In some embodiments, the electrical impedance value of the first twisted pair is within about 3, about 5, about 10, or about 15 Ohms of the electrical impedance value of the second, third, and fourth twisted pairs.

In some embodiments, the method further comprises providing a pair of solid polymer insulated conductors, wherein the polymer insulated conductors are insulated by a solid polymer and twisting the pair of solid polymer insulated conductors around each other to form a solid twisted pair.

Some disclosed embodiments relate to a method of manufacturing a communications cable comprising, providing a first pair of insulated conductors, wherein each insulated conductor of the first pair of insulated conductors includes a conductor electrically insulated by a foam polymer layer having a first foam thickness and a solid polymer layer having a first solid thickness, the conductors of the first pair having a first outer diameter. The method further comprises providing a second pair of insulated conductors, wherein each insulated conductor of the second pair of insulated conductors includes a conductor electrically insulated by a foam polymer layer having a second foam thickness and a solid polymer layer having a second solid thickness, the conductors of the second pair having a second outer diameter. In some embodiments, the method further comprises twisting the first pair of insulated conductors around each other to form a first twisted pair having a first lay length and twisting the second pair of insulated conductors around each other to form a second twisted pair having a second lay length. In some embodiments, the ratio of the first foam thickness to first solid thickness is greater than the ratio of the second foam thickness to second solid thickness, and the first lay length is shorter than the second lay length.

In some embodiments, the method further comprises hardening the polymer foam layer of the first pair of insulated conductors prior to twisting the first pair of insulated conductors.

In some embodiments, the first and second outer diameters are within 15% of each other, or withing 10% of each other, or within 5% of each other, or within 3% of each other.

In some embodiments, the first twisted pair has first propagation delay over 100 meters and the second twisted pair has a second propagation delay over 100 meters and the first and second propagation delay over 100 meters are within about 60, about 50, about 40, about 30, or about 20 nanoseconds of each other.

In some embodiments, the method further comprises providing a third pair of insulated conductors, wherein each insulated conductor of the third pair of insulated conductors includes a conductor electrically insulated by a foam polymer layer having a third foam thickness and a solid polymer layer having a third solid thickness, the conductors of the third pair having a third outer diameter and providing a fourth pair of insulated conductors, wherein each insulated conductor of the fourth pair of insulated conductors includes a conductor electrically insulated by a foam polymer layer having a fourth foam thickness and a solid polymer layer having a fourth solid thickness, the conductors of the fourth pair having a fourth outer diameter.

In some embodiments, the method further comprises twisting the third pair of insulated conductors around each other to form a third twisted pair having a third lay length, and twisting the fourth pair of insulated conductors around each other to form a fourth twisted pair having a fourth lay length. In some embodiments, the ratio of the third foam thickness to third solid thickness is less than the ratio of the second foam thickness to second solid thickness and greater than the ratio of the fourth foam thickness to fourth solid thickness. In some embodiments, the third lay length is longer than the second lay length and shorter than the fourth lay length. In some embodiments, the first, second, third, and fourth outer diameters are within 25% of each other, or within 20%, or within 15%, or within 10%, or within 5%, or within 3% of each other.

In some embodiments, a communications cable comprises at least one twisted pair of insulated conductors, wherein the insulated conductors comprise a conductor and a polymer insulation layer surrounding a circumference of the conductor, wherein the twisted pair has a lay length of less than about 12 mm and a signal propagation delay of less than about 5.2 nanoseconds per meter; and wherein the communications cable passes the NFPA 262 Steiner Tunnel Flame Test. In some embodiments, the cable is a Category 6A cable or can transmit at least 10 gigabits of data per second at a frequency of at least 500 MHz.

In some embodiments, the cable further comprises a second twisted pair wherein the second twisted pair has a lay length of less than about 9 mm and a signal propagation delay of less than about 5.2 nanoseconds per meter. In some embodiments, the insulation layer of the second twisted pair comprises a foamed polymer. The In some embodiments, the foamed polymer insulation layer is foamed at least about 10%, about 20%, about 25%, or about 30%.

In some embodiments, the cable has a characteristic impedance of between about 85 and 115 Ohms, between about 90 and 110 Ohms, or between about 95 and 105 Ohms at a frequency of 100 MHz or greater.

In some embodiments, the insulation layer of at least one twisted pair comprises a fluoropolymer and wherein the insulation layer of a different twisted pair comprises a non-fluoropolymer.

In some embodiments, a communications cable comprises a first twisted pair of insulated conductors and a second twisted pair or insulated conductors, wherein the insulated conductors comprise a conductor and a polymer insulation layer surrounding a circumference of the conductor, wherein the first twisted pair has a lay length of less than 12 mm and a signal propagation delay of less than 5.2 nanoseconds per meter and wherein the second twisted pair has a shorter lay length than the first twisted pair. In some embodiments, the insulation layer of one of the twisted pairs comprises a fluoropolymer and the insulation layer of the other twisted pair comprises a non-fluoropolymer. In some embodiments, the communications cable passes the NFPA 262 Steiner Tunnel Flame Test. In some embodiments, the first twisted pair has a lay length of less than about 11 mm, about 10 mm, about 9 mm, about 8 mm, or about 7 mm.

In some embodiments, a communications cable comprises at least one twisted pair of insulated conductors positioned within an outer jacket, wherein the twisted pair comprises two insulated singles, each insulated single comprising a conductor and an insulation layer surrounding a circumference of the conductor and wherein the insulation layer comprises a foamed fluorine-free polymer with foam cells, The twisted pair having a lay length of less than about 12 mm, the twisted pair having a signal propagation delay of less than about 520 nanoseconds per 100 meters; and wherein the communications cable passes the NFPA 262 Steiner Tunnel Flame Test.

In some embodiments, the foam cells have a major diameter and a minor diameter, and a cross-section of the insulation layer shows at least 70% of the foam cells have a minor diameter that is greater than or equal to 80% of the major diameter. In some embodiments, at least about 60%, about 75%, about 85%, or about 90% of the foam cells have a minor diameter that is greater than or equal to 90%, or 85%, or 75%, or 70% of the major diameter.

In some embodiments, a communications cable comprises a first, second, third, and fourth twisted pair of polymer insulated conductors wherein the first and second twisted pairs comprise a foam polymer insulation layer and wherein the third and fourth twisted pairs comprise a solid polymer insulation layer. In some embodiments, the lay lengths of the first and second twisted pairs are shorter than the lay lengths of the third and fourth twisted pairs, the data transfer rate of the cable is at least 10 gb/s at a frequency of at least 500 MHz; and the cable is at least about 120 m long.

In some embodiments, the length of the cable is at least about 130 m, about 150 m, or about 180 m long. In some embodiments, the cable is a Category 6A cable.

In some embodiments, the lay length of the first twisted pair is less than about 12 mm, about 10 mm, about 8 mm, or about 7 mm.

In some embodiments, a lighter, smaller, and/or more useful cable may be produced by increasing the hardness of the polymer cable components prior to or during manufacturing. Less total insulation material may be required to achieve the same electrical performance if the cable components are not compressed or otherwise deformed. The total thickness of insulation layers may be reduced if the insulation layer is compressed less due to the increase in stress/strain response and hardness during manufacturing.

The methods, systems, and embodiments described herein are generally directed to adjusting the stress/strain response and/or hardness of polymer components. The polymers contemplated herein include, but are not limited to thermoplastics, thermosets, rubbers, and/or elastomers, each of which may be foamed or solid and may contain a variety of additives and/or fire retardants. Specific polymers contemplated include, but are not limited to: linear low density polyethylene-LLDPE, high density polyethylene-HDPE, polyethylene-pe, perfluoroalkoxy alkanes-PFA, polytetrafluoroethylene-PTFE, polyvinylidene fluoride-PVDF, ethylene chlorotrifluoroethylene-ECTFE, tetrafluoroethylene, perfluoromethylvinylether-MFA, polyphenylene sulfide-PPS, polyether ketone-PEEK, polyetherketone-PEK, polyethylenimine-PEI, fluorinated ethylene propylene-FEP, ethylenepropylene tetrafluoroethylene-ETFE, ethylene fluoroethylene propylene-EFEP, polypropylene-PP, nylon-PA, polyvinylchloride-PVC, polycarbonate-PC, acrylonitrile butadiene styrene-ABS, polystyrene-PS, polyesters like polyethylene terephthalate (PET), polyimides-PI, polyamide, polyimides, polyamide-imide-PAI, natural rubber, synthetic rubber, fluorelastomer-FKM, silicone (such as dimethylpolysiloxane), PVdF, PEBA, foams thereof, blends thereof, and alloys thereof.

Those skilled in the art will recognize improvements and modification to the preferred embodiments of the present disclosure. All such improvements and modifications are considered within the scope of the concepts disclosed herein and the claims that follow. It is to be understood that any given elements of the disclosed embodiments of the invention may be embodied in a single structure, a single step, a single substance, or the like. Similarly, a given element of the disclosed embodiment may be embodied in multiple structures, steps, substances, or the like.

The foregoing description and accompanying drawings illustrate and describe certain processes, machines, manufactures, and compositions of matter, some of which embody the invention(s). Such descriptions or illustrations are not intended to limit the scope of what can be claimed, and are provided as aids in understanding the claims, enabling the making and use of what is claimed, and teaching the best mode of use of the invention(s). If this description and accompanying drawings are interpreted to disclose only a certain embodiment or embodiments, it shall not be construed to limit what can be claimed to that embodiment or embodiments. Any examples or embodiments of the invention described herein are not intended to indicate that what is claimed must be coextensive with such examples or embodiments. Where it is stated that the invention(s) or embodiments thereof achieve one or more objectives, it is not intended to limit what can be claimed to versions capable of achieving all such objectives. Any statements in this description criticizing the prior art are not intended to limit what is claimed to exclude any aspects of the prior art.

Additionally, the disclosure shows and describes certain embodiments of the processes, machines, manufactures, compositions of matter, and other teachings disclosed, but it is to be understood that the teachings of the present disclosure are capable of use in various other combinations, modifications, and environments and is capable of changes or modifications within the scope of the teachings as expressed herein.

Any section headings herein are provided only for consistency with the suggestions of 37 C.F.R. § 1.77 or otherwise to provide organizational queues. These headings shall not limit or characterize the invention(s) set forth herein.

The present disclosure provides:
(1) a communications cable comprising:
at least one twisted pair of insulated conductors, wherein the insulated conductors comprise a conductor and an insulation layer surrounding a circumference of the conductor and wherein the insulation layer comprises a foamed polymer with foam cells, the foam cells having a major diameter and a minor diameter, and wherein a cross-section of the insulation layer shows at least 50% of the foam cells have a minor diameter that is greater than or equal to 80% of the major diameter,
(2) the communications cable of (1), wherein at least one insulation layer of the twisted pair comprises a compressed region and a non-compressed region, at least 50% the foam cells within the compressed region having an average minor diameter that is greater than or equal to 80% of the average major diameter,
(3) the communications cable of (1), wherein at least one insulation layer of the twisted pair comprises a compressed region and a non-compressed region, wherein the foam cell to polymer ratio within the compressed region is greater than or equal to 90% of the foam cell to polymer ratio in the non-compressed region,
(4) the communications cable of (1), wherein at least one insulation layer of the twisted pair comprises a compressed region and a non-compressed region, the weight per volume of the foam insulation within the compressed region being less than or equal to 125% of the weight per volume of the foam insulation in the non-compressed region,
(5) a communications cable of (1), wherein the insulation layer comprises a fluoropolymer,
(6) a communications cable of (1), wherein the insulation layer comprises FEP,
(7) a communications cable of (1), wherein the insulation layer comprises a fluoropolymer foam with at least 100 unstable end groups per million carbon atoms,
(8) a communications cable of (1), wherein the insulation layer comprises a fluoropolymer foam with at least 200 unstable end groups per million carbon atoms,
(9) a communications cable of (1), wherein the insulation layer contains at least 15% air by volume,
(10) a method of manufacturing a twisted pair comprising:
providing a first foam insulated conductor comprising a first conductor electrically insulated by a first foam insulation layer and a second foam insulated conductor comprising second conductor electrically insulated by a second foam insulation layer; the first foam insulation layer having a first hardness at ambient conditions;
hardening the first foam insulation layer to a second hardness, the second hardness being greater than the first hardness;
twisting the first and second foam insulated conductors around each other to form a twisted pair while the first foam insulation layer is at the second hardness,
(11) the method of (10), wherein the second foam insulation layer has a third hardness, the method further comprising hardening the second foam insulation layer to a fourth hardness, the fourth hardness being greater than the third hardness,
(12) the method of (10), wherein the step of twisting the first and second foam insulated conductors around each other occurs within 10 seconds after hardening the first foam insulation layer to a second hardness,
(13) the method of (10), wherein the first and second foam insulated conductors are twisted around each other at greater than 2000 twists per minute (TPM),
(14) the method of (10), wherein the step of hardening the first foam insulation layer comprises cooling the first foam insulation layer,
(15) a method of manufacturing a communications cable comprising:
providing a first polymer foam cable component, the polymer foam cable component comprising a polymer foam with foam cells, the first polymer foam cable component having a first hardness under ambient conditions;
hardening the first polymer foam cable component to a second hardness, the second hardness being greater than the first hardness;
compressing at least a portion of the first polymer foam cable component to form a communications cable while the first polymer foam cable is at the second hardness,
(16) the method of (15), wherein the first polymer foam cable component comprises a fluoropolymer,
(17) the method of (15), wherein the first polymer foam cable component comprises FEP,
(18) the method of (15), wherein the first polymer foam cable component comprises FEP with greater than 80 unstable end groups per million carbon atoms,
(19) the method of (15), wherein the composition of the first polymer foam cable component is unchanged during the step of hardening the first polymer foam cable component to a second hardness,
(20) the method of (15), further comprising the step of allowing the first polymer foam cable component to return to the first hardness,
(21) a method of installing communications cables in a building comprising:
providing a first polymer foam cable component, the polymer foam cable component comprising a polymer foam with foam cells, the first polymer foam cable component having a first hardness under ambient conditions;
hardening the first polymer foam cable component to a second hardness, the second hardness being greater than the first hardness;
positioning at least a portion of the first polymer foam cable component into a desired location of a building while the first polymer foam cable component is at the second hardness,
(22) a method of manufacturing a communications cable comprising:
providing a plurality of polymer insulated conductors, wherein the polymer insulated conductors are insulated by a polymer foam having a first hardness under ambient conditions;
dividing the plurality of polymer insulated conductors into pairs;
hardening the polymer foam of a first pair of polymer insulated conductors to a second hardness, the second hardness being greater than the first hardness;
twisting the first pair of polymer insulated conductors around each other to form a first twisted pair;
hardening the polymer foam of a second pair of polymer insulated conductors to a third hardness, the third hardness being greater than the second hardness; and
twisting the second pair of polymer insulated conductors around each other to form a second twisted pair,
(23) the method of (22) further comprising, hardening the polymer foam of a third pair of polymer insulated conductors to a fourth hardness, the fourth hardness being greater than the third hardness; and twisting the third pair of polymer insulated conductors around each other to form a third twisted pair,
(24) the method of (22), wherein the polymer foam comprises a fluoropolymer,
(25) the method of (22), wherein the step of twisting the first pair of polymer insulated conductors around each other occurs within 10 seconds after hardening the polymer foam of a first pair of polymer insulated conductors to a second hardness,
(26) the method of (22), wherein the polymer foam of the first twisted pair contains at least 15% air by volume,
(27) the method of (22), wherein a lay length of the first twisted pair is longer than a lay length of the second twisted pair,
(28) the method of (22), further comprising the steps of providing a third pair of solid polymer insulated conductors, and twisting the third pair of solid polymer insulated conductors around each other to form a third twisted pair,
(29) the method of (22), wherein an electrical impedance value of the first twisted pair is within 10 Ohms of an electrical impedance value of the second twisted pair,
(30) a method of manufacturing a communications cable comprising:
providing a first pair of insulated conductors, wherein each of the first pair of insulated conductors includes a conductor electrically insulated by a polymer foam layer having a first foam thickness and a solid polymer layer having a first solid thickness, the conductors of the first pair having a first outer diameter;
providing a second pair of insulated conductors, wherein each of the second pair of insulated conductors includes a conductor electrically insulated by a polymer foam layer having a second foam thickness and a solid polymer layer having a second solid thickness, the conductors of the second pair having a second outer diameter;
twisting the first pair of insulated conductors around each other to form a first twisted pair having a first lay length;
twisting the second pair of insulated conductors around each other to form a second twisted pair having a second lay length;
wherein the ratio of the first foam thickness to first solid thickness is greater than the ratio of the second foam thickness to second solid thickness, and wherein the first lay length is shorter than the second lay length,
(31) the method of (30), wherein the first and second outer diameters are within 10% of each other,
(32) the method of (30), further comprising hardening the polymer foam layer of the first pair of insulated conductors prior to twisting the first pair of insulated conductors,
(33) the method of (30), wherein the first twisted pair has first propagation delay over 100 meters and the second twisted pair has a second propagation delay over 100 meters and the first and second propagation delay over 100 meters are within 50 nanoseconds of each other,
(34) the method of (30), further comprising providing a third pair of insulated conductors, wherein each of the third pair of insulated conductors includes a conductor electrically insulated by a polymer foam layer having a third foam thickness and a solid polymer layer having a third solid thickness, the conductors of the third pair having a third outer diameter;
providing a fourth pair of insulated conductors, wherein each of the fourth pair of insulated conductors includes a conductor electrically insulated by a polymer foam layer having a fourth foam thickness and a solid polymer layer having a fourth solid thickness, the conductors of the fourth pair having a fourth outer diameter;
twisting the third pair of insulated conductors around each other to form a third twisted pair having a third lay length;
twisting the fourth pair of insulated conductors around each other to form a fourth twisted pair having a fourth lay length;
wherein the ratio of the third foam thickness to third solid thickness is less than the ratio of the second foam thickness to second solid thickness and greater than the ratio of the fourth foam thickness to fourth solid thickness, and wherein the third lay length is longer than the second lay length and shorter than the fourth lay length, and wherein the first, second, third, and fourth outer diameters are within 15% of each other,
(35) a communications cable comprising:
at least one twisted pair of insulated conductors, wherein the insulated conductors comprise a conductor and a polymer insulation layer surrounding a circumference of the conductor;
wherein the twisted pair has a lay length of less than about 12 mm and a signal propagation delay of less than about 5.2 nanoseconds per meter; and
wherein the communications cable passes the NFPA 262 Steiner Tunnel Flame Test,
(36) the communications cable of (35), wherein the cable is a Category 6A cable,
(37) the communications cable of (35), further comprising a second twisted pair wherein the second twisted pair has a lay length of less than about 9 mm and a signal propagation delay of less than about 5.2 nanoseconds per meter,
(38) the communications cable of (37), wherein the insulation layer of the second twisted pair comprises a foamed polymer,
(39) the communications cable of (38), wherein the foamed polymer insulation layer is foamed at least 25%,
(40) the communications cable of (37), wherein the insulation layer of at least one twisted pair comprises a fluoropolymer and wherein the insulation layer of a different twisted pair comprises a non-fluoropolymer,
(41) the communications cable of (35), wherein the cable has a characteristic impedance of between about 85 and 115 Ohms at a frequency of 100 MHz or greater,
(42) a communications cable comprising:
a first twisted pair of insulated conductors and a second twisted pair of insulated conductors, wherein the insulated conductors comprise a conductor and a polymer insulation layer surrounding a circumference of the conductor, wherein the first twisted pair has a lay length of less than 12 mm and a signal propagation delay of less than 5.2 nanoseconds per meter and wherein the second twisted pair has a shorter lay length than the first twisted pair; wherein the insulation layer of one of the twisted pairs comprises a fluoropolymer and wherein the insulation layer of the other twisted pair comprises a non-fluoropolymer; and wherein the communications cable passes the NFPA 262 Steiner Tunnel Flame Test,
(43) a communications cable comprising:
at least one twisted pair of insulated conductors positioned within an outer jacket, wherein the twisted pair comprises two insulated singles, each insulated single comprising a conductor and an insulation layer surrounding a circumference of the conductor and wherein the insulation layer comprises a foamed fluorine-free polymer with foam cells;
the twisted pair having a lay length of less than about 12 mm;
the twisted pair having a signal propagation delay of less than about 520 nanoseconds per 100 meters; and
wherein the communications cable passes the NFPA 262 Steiner Tunnel Flame Test,
(44) the communications cable of (43), wherein the foam cells have a major diameter and a minor diameter, and wherein a cross-section of the insulation layer shows at least 70% of the foam cells have a minor diameter that is greater than or equal to 80% of the major diameter,
(45) a communications cable comprising a first, second, third, and fourth twisted pair of polymer insulated conductors wherein the first and second twisted pairs comprise a foam polymer insulation layer and wherein the third and fourth twisted pairs comprise a solid polymer insulation layer;
wherein the lay lengths of the first and second twisted pairs are shorter than the lay lengths of the third and fourth twisted pairs;
wherein the data transfer rate of the cable is at least 10 gb/s at a frequency of at least 500 MHz; and
wherein the cable is at least 120 m long,
(46) the communications cable of (45), wherein the length of the cable is at least 150 m long,
(47) the communications cable of (45), wherein the cable is a Category 6A cable,
(48) the communications cable of (45), wherein the lay length of the first twisted pair is less than about 8 mm.

1: A communications cable comprising:
at least one twisted pair of insulated conductors, wherein the insulated conductors comprise a conductor and an insulation layer surrounding a circumference of the conductor and wherein the insulation layer comprises a foamed polymer with foam cells, the foam cells having a major diameter and a minor diameter, and wherein a cross-section of the insulation layer shows at least 50% of the foam cells have a minor diameter that is greater than or equal to 80% of the major diameter.

2: The communications cable of claim 1, wherein at least one insulation layer of the twisted pair comprises a compressed region and a non-compressed region, at least 50% the foam cells within the compressed region having an average minor diameter that is greater than or equal to 80% of the average major diameter.

3: The communications cable of claim 1, wherein at least one insulation layer of the twisted pair comprises a compressed region and a non-compressed region, wherein the foam cell to polymer ratio within the compressed region is greater than or equal to 90% of the foam cell to polymer ratio in the non-compressed region.

4: The communications cable of claim 1, wherein at least one insulation layer of the twisted pair comprises a compressed region and a non-compressed region, the weight per volume of the foam insulation within the compressed region being less than or equal to 125% of the weight per volume of the foam insulation in the non-compressed region.

5: A communications cable of claim 1, wherein the insulation layer comprises a fluoropolymer.

6: A communications cable of claim 1, wherein the insulation layer comprises FEP.

7: A communications cable of claim 1, wherein the insulation layer comprises a fluoropolymer foam with at least 100 unstable end groups per million carbon atoms.

8: A communications cable of claim 1, wherein the insulation layer contains at least 15% air by volume.

9: A method of manufacturing a twisted pair comprising:
providing a first foam insulated conductor comprising a first conductor electrically insulated by a first foam insulation layer and a second foam insulated conductor comprising second conductor electrically insulated by a second foam insulation layer; the first foam insulation layer having a first hardness at ambient conditions;
hardening the first foam insulation layer to a second hardness, the second hardness being greater than the first hardness;
twisting the first and second foam insulated conductors around each other to form a twisted pair while the first foam insulation layer is at the second hardness.

10: The method of claim 9, wherein the second foam insulation layer has a third hardness, the method further comprising hardening the second foam insulation layer to a fourth hardness, the fourth hardness being greater than the third hardness.

11: The method of claim 9, wherein the step of twisting the first and second foam insulated conductors around each other occurs within 10 seconds after hardening the first foam insulation layer to a second hardness.

12: The method of claim 9, wherein the first and second foam insulated conductors are twisted around each other at greater than 2000 twists per minute (TPM).

13: The method of claim 9, wherein the step of hardening the first foam insulation layer comprises cooling the first foam insulation layer.

14: A method of manufacturing a communications cable comprising:
providing a first polymer foam cable component, the polymer foam cable component comprising a polymer foam with foam cells, the first polymer foam cable component having a first hardness under ambient conditions;
hardening the first polymer foam cable component to a second hardness, the second hardness being greater than the first hardness;
compressing at least a portion of the first polymer foam cable component to form a communications cable while the first polymer foam cable is at the second hardness.

15: The method of claim 14, wherein the first polymer foam cable component comprises a fluoropolymer.

16: The method of claim 14, wherein the first polymer foam cable component comprises FEP.

17: The method of claim 14, wherein the first polymer foam cable component comprises FEP with greater than 80 unstable end groups per million carbon atoms.

18: The method of claim 14, wherein the composition of the first polymer foam cable component is unchanged during the step of hardening the first polymer foam cable component to a second hardness.

19: The method of claim 14, further comprising the step of allowing the first polymer foam cable component to return to the first hardness.
